(19) United States
(12) Patent Application Publication
(10) Pub. No.: US 2022/0363609 A1
(43) Pub. Date: Nov. 17, 2022

(54) SELECTIVE WEED CONTROL

(71) Applicant: SYNGENTA CROP PROTECTION AG, Basel (CH)

(72) Inventors: Christopher Glen CLEMENS, Minneapolis, MN (US); Cheryl Lynn DUNNE, Bracknell, Berkshire (GB)

(73) Assignee: SYNGENTA CROP PROTECTION AG, Basel (CH)

(21) Appl. No.: 17/624,161

(22) PCT Filed: Jun. 25, 2020
(86) PCT No.: PCT/EP2020/067928

§ 371 Date: Dec. 30, 2021

Related U.S. Application Data
(60) Provisional application No. 62/870,143, filed on Jul. 3, 2019.

(51) Int. Cl. C05G 3/60; A01N 37/40; A01N 43/36; A01N 43/40; A01N 43/90; A01N 47/38

(52) U.S. Cl. CPC C05G 3/60; A01N 37/40; A01N 43/36; A01N 43/40; A01N 43/90; A01N 47/38

(57) ABSTRACT

The present invention provides a method of selectively controlling unwanted vegetation at a locus comprising a crop and the unwanted vegetation, wherein the method comprises applying to the locus a herbicidal composition comprising: —a. bicyclopyrone; b. a nitrogen-based fertilizer additive; and c. an ALS-inhibiting herbicide. The invention further provides an herbicide composition comprising (a) bicyclopyrone, (b) a nitrogen additive, and (c) an ALS-inhibiting herbicide.

The protection of crops from weeds and other vegetation which inhibit crop growth is a constantly recurring problem in agriculture. To help combat this problem, researchers in the field of synthetic chemistry have produced an extensive variety of chemicals and chemical formulations effective in the control of such unwanted growth. Chemical herbicides of many types have been disclosed in the literature and a large number are in commercial use.

Bicyclopyrone is an herbicide which is used to control problematic weeds in several crops, including corn and cereals. Herbicides are often tank-mixed with other components prior to application. Combinations of bicyclopyrone with numerous mixing partners is disclosed, for example, in EP1388285.

It has now been observed that application of bicyclopyrone at certain applications rates, in conjunction with a nitrogen-based fertilizer additive, can cause some damage to the crop, especially in cereals such as wheat. However, it has now been unexpectedly discovered that this damage can be significantly mitigated if the bicyclopyrone is applied with the nitrogen-based fertilizer additive in the presence of an acetolactate synthase (ALS)-inhibiting herbicide. Whilst a dramatic reduction in crop damage is observed, good overall weed control is maintained.

Thus, according to the present invention there is provided a method of selectively controlling weeds at a locus comprising a crop and the unwanted vegetation (weeds), wherein the method comprises applying to the locus an herbicidal composition comprising:—
a. bicyclopyrone;
b. a nitrogen-based fertilizer additive; and
c. an ALS-inhibiting herbicide.

In said method the amount of components (a), (b) & (c) applied to the locus provides control of the unwanted vegetation and the amount of component (c) applied reduces the herbicidal effect of component (a) on the crop.

In a preferred embodiment of the present invention the nitrogen-based fertilizer additive is selected from the group consisting of ammonium sulfate (AMS), Urea Ammonium Nitrate (UAN), nitrogen-based adjuvants, slow-release nitrogen blends, and other micronutrient based additives which contain nitrogen. In a preferred embodiment of the present invention the nitrogen-based fertilizer additive is selected from ammonium sulfate (AMS) and Urea Ammonium Nitrate (UAN).

In another preferred embodiment of the present invention the ALS-inhibiting herbicide is selected from the group consisting of an imidazilinone herbicide, a pyrimidinylthiobenzoic acid herbicide, a sulfonylaminocarbonyltriazolinone herbicide, a sulfonylurea herbicide and a triazolopyrimidine herbicide.

In another preferred embodiment of the present invention the ALS-inhibiting herbicide is a sulfonylaminocarbonyltriazolinone herbicide, preferably flucarbazone.

In another preferred embodiment of the present invention the ALS-inhibiting herbicide is sulfonylurea herbicide, preferably mesosulfuron.

In another preferred embodiment of the present invention the ALS-inhibiting herbicide is triazolopyrimidine herbicide, preferably pyroxsulam.

The rate of application of the herbicide components may vary within wide limits and depends on the nature of the soil, the method of application (pre- or post-emergence, etc.), the crop plant, the undesired vegetation to be controlled, the prevailing climatic conditions, and other factors governed by the method of application, the time of application and the target crop. Typically bicyclopyrone is applied at a rate from 37.5 to 50 g ai/ha. Typically the ALS-inhibiting herbicide is applied at a rate from 10 to 60 gai/ha, more preferably from 15 to 55 g ai/ha. Typically, the nitrogen-based fertilizer additive is present in the herbicidal composition at a concentration of 0.25 to 50% v/v.

Components (a), (b) & (c) will typically be applied to the locus simultaneously in a single combined herbicidal composition. However, it may be envisaged that components (a), (b) and (c) separately, in any order to the locus. It should be understood that components (a), (b) and (c) may be applied to the locus either pre-emergence and/or post-emergence. Preferably the components are both applied post emergence of the unwanted vegetation.

In the context of the present invention crop preferably means a cereal crop (for example, spring wheat, winter wheat, durum wheat and barley). In a preferred embodiment of the present invention the crop is spring or winter wheat. Unwanted vegetation is to be understood as those plants that affect the growth and quality of the crop and examples include grasses, sedges and broad-leaved weeds. The term “locus” is to be understood to mean, for example, areas of cultivation such as areas of land on which the crop plants are already growing or in which the seed material of those crop plants has been sown. Examples of unwanted vegetation typically include Ipomoea spp. (e.g Ipomoea grandifolia, Ipomoea acuminate, Ipomoea nil, Ipomea hederacea), Echinochloa spp., Digitaria spp. (e.g Digitaria horizontalis), Setaria spp., Sorghum spp., Brachiaria spp. (e.g Brachiaria decumbens and Brachiaria plantaginea), Kochia spp., Sida spp. (e.g Sida rhombifolia), Portulaca spp. (e.g Portulaca oleracea), Panicum spp. (e.g Panicum maximum), Cenchrus spp. (e.g Cenchrus echinatus), Cyperus spp, Eleusine spp. (e.g Eleusine indica), Chenopodium spp., Euphorbia spp. (e.g Euphorbia heterophylla) and Amarathus spp. (e.g Amaranthus viridis. Amaranthus retroflexus, Amaranthus hybridus). The method of the present invention is shown to provide good control of grass weeds—at least as good as would be expected with regard to the use of the individual active ingredients alone. Particularly good control of Bromus spp. (e.g Bromus tectorum) is observed

The control of the unwanted vegetation ensures satisfactory crop yield and quality, and the grower of the crop has often to balance the costs associated with the use of compounds with the resulting yield, but generally an increase of, for example, at least 5% yield of a crop which has undergone compound treatment compared with an untreated crop is considered control by the compound.

It should also be appreciated that the one or more additional pesticides e.g herbicides, herbicide safeners, plant growth regulators, fertilizers, insecticides and/or fungicides, may be applied to the locus in the method of the present invention. In particular, the addition of bromoxynil is preferred—and thus a herbicidal composition comprising bicyclopyrone+bromoxynil+ALS-inhibiting herbicide (preferably mesosulfuron, flucarbazone, or pyroxsulam) is particularly preferred.

The present invention still further provides a herbicidal composition comprising:
a. bicyclopyrone;
b. a nitrogen-based fertilizer additive; and
c. an ALS-inhibiting herbicide.

The amount and ratio of components (a), (b) and (c) in the herbicide composition can vary depending on whether the composition is, for example, a pre-mix concentrate or a diluted ready to use composition in the actual spray tank. Typically, the herbicide components will be provided as a concentrate (or pre-mix concentrate) and the nitrogen-based fertilizer additive will be added in the spray tank.

The herbicidal composition of the present invention will typically further comprise composition adjuvants conventionally used in formulation technology (also known as formulation auxiliaries), such as solvents, solid carriers or surfactants, for example, into emulsifiable concentrates, directly sprayable or dilutable solutions, wettable powders, soluble powders, dusts, granules or microcapsules, as described in WO 97/34483, pages 9 to 13. As with the nature of the formulation, the methods of application, such as spraying, atomising, dusting, wetting, scattering or pouring, are chosen in accordance with the intended objectives and the prevailing circumstances. The formulations can be prepared in a known manner, e.g., by intimately mixing and/or grinding the active ingredients with the formulation adjuvants, e.g., solvents or solid carriers. In addition, surface-active compounds (surfactants) may also be used in the preparation of the formulations.

Examples of solvents and solid carriers are given, for example, in WO 97/34485, page 6. Depending on the nature of the active ingredients to be formulated, suitable surface-active compounds are non-ionic, cationic and/or anionic surfactants and surfactant mixtures having good emulsifying, dispersing and wetting properties. Examples of suitable anionic, non-ionic and cationic surfactants are listed, for example, in WO 97/34485, pages 7 and 8. Also suitable for the preparation of the herbicidal compositions according to the invention are the surfactants conventionally employed in formulation technology, which are described, inter alia, in “McCutcheon's Detergents and Emulsifiers Annual” MC Publishing Corp., Ridgewood N.J., 1981, Stache, H., “Tensid-Taschenbuch”, Carl Hanser Verlag, Munich/Vienna, 1981 and M. and J. Ash, “Encyclopaedia of Surfactants”, Vol I-III, Chemical Publishing Co., New York, 1980-81.

The herbicidal formulations usually contain from 0.1 to 99% by weight, especially from 0.1 to 95% by weight, of active ingredient, from 0 to 25% by weight, especially from 0.1 to 25% by weight, of a surfactant, and the balance a solid or liquid formulation adjuvant.

Whereas commercial products are usually formulated as concentrates (also known as pre-mix), the end user will normally employ dilute formulations. The compositions may also comprise further ingredients, such as stabilisers, e.g., vegetable oils or epoxidised vegetable oils (epoxidised coconut oil, rapeseed oil or soybean oil), antifoams, e.g., silicone oil, preservatives, viscosity regulators, binders, tackifiers and also fertilisers or other active ingredients.

Preferred formulations have especially the following compositions:
(%=percent by weight)

### Emulsifiable Concentrates:

active ingredient mixture: 1 to 90%, preferably 5 to 20%
surfactant: 1 to 30%, preferably 10 to 20%
liquid carrier: balance

### Dusts:

active ingredient mixture: 0.1 to 10%, preferably 0.1 to 5%
solid carrier: 99.9 to 90%, preferably 99.9 to 95%

### Suspension Concentrates:

active ingredient mixture: 5 to 75%, preferably 10 to 50%
water: 94 to 24%, preferably 88 to 30%
surfactant: balance

### Wettable Powders:

active ingredient mixture: 0.5 to 90%, preferably 1 to 80%
surfactant: 0.5 to 20%, preferably 1 to 15%
solid carrier: balance

### Granules:

active ingredient mixture: 0.1 to 30%, preferably 0.5 to 15%
solid carrier: 99.9 to 70%, preferably 99.5 to 85%
Examples are specific formulations include:

| F1. Emulsifiable concentrates | a) | b) | c) | d) |
|---|---|---|---|---|
| active ingredient mixture | 5% | 10% | 25% | 50% |
| calcium dodecylbenzenesulfonate | 6% | 8% | 6% | 8% |
| castor oil polyglycol ether | 4% | — | 4% | 4% |
| (36 mol of ethylene oxide) | | | | |
| octylphenol polyglycol ether | — | 4% | — | 2% |
| (7-8 mol of ethylene oxide) | | | | |
| cyclohexanone | — | — | 10% | 20% |
| arom. hydrocarbon mixture | 85% | 78% | 55% | 16% |
| C₉-C₁₂ | | | | |

Emulsions of any desired concentration can be obtained from such concentrates by dilution with water.

| F2. Solutions | a) | b) | c) | d) |
|---|---|---|---|---|
| active ingredient mixture | 5% | 10% | 50% | 90% |
| 1-methoxy-3-(3-methoxy- | — | 20% | 20% | — |
| propoxy)-propane | | | | |
| polyethylene glycol MW 400 | 20% | 10% | — | — |
| N-methyl-2-pyrrolidone | — | — | 30% | 10% |
| arom. hydrocarbon mixture | 75% | 60% | — | — |
| C₉-C₁₂ | | | | |

The solutions are suitable for use in the form of microdrops.

| F3. Wettable powders | a) | b) | c) | d) |
|---|---|---|---|---|
| active ingredient mixture | 5% | 25% | 50% | 80% |
| sodium lignosulfonate | 4% | — | 3% | — |
| sodium lauryl sulfate | 2% | 3% | — | 4% |
| sodium diisobutylnaphthalene- | — | 6% | 5% | 6% |
| sulfonate | | | | |
| octylphenol polyglycol ether | — | 1% | 2% | — |
| (7-8 mol of ethylene oxide) | | | | |
| highly dispersed silicic acid | 1% | 3% | 5% | 10% |
| kaolin | 88% | 62% | 35% | — |

The active ingredient is mixed thoroughly with the adjuvants and the mixture is thoroughly ground in a suitable mill, affording wettable powders which can be diluted with water to give suspensions of any desired concentration.

| F4. Coated granules | a) | b) | c) |
|---|---|---|---|
| active ingredient mixture | 0.1% | 5% | 15% |
| highly dispersed silicic acid | 0.9% | 2% | 2% |
| inorganic carrier | 99.0% | 93% | 83% |
| (diameter 0.1-1 mm) | | | |
| e.g., CaCO₃ or SiO₂ | | | |

The active ingredient is dissolved in methylene chloride and applied to the carrier by spraying, and the solvent is then evaporated off in vacuo.

| F5. Coated granules | a) | b) | c) |
|---|---|---|---|
| active ingredient mixture | 0.1% | 5% | 15% |
| polyethylene glycol MW 200 | 1.0% | 2% | 3% |
| highly dispersed silicic acid | 0.9% | 1% | 2% |
| inorganic carrier | 98.0% | 92% | 80% |
| (diameter 0.1-1 mm) | | | |
| e.g., CaCO₃ or SiO₂ | | | |

The finely ground active ingredient is uniformly applied, in a mixer, to the carrier moistened with polyethylene glycol. Non-dusty coated granules are obtained in this manner.

| F6. Extruder granules | a) | b) | c) | d) |
|---|---|---|---|---|
| active ingredient mixture | 0.1% | 3% | 5% | 15% |
| sodium lignosulfonate | 1.5% | 2% | 3% | 4% |
| carboxymethylcellulose | 1.4% | 2% | 2% | 2% |
| kaolin | 97.0% | 93% | 90% | 79% |

The active ingredient is mixed and ground with the adjuvants, and the mixture is moistened with water. The mixture is extruded and then dried in a stream of air.

| F7. Dusts | a) | b) | c) |
|---|---|---|---|
| active ingredient mixture | 0.1% | 1% | 5% |
| talcum | 39.9% | 49% | 35% |
| kaolin | 60.0% | 50% | 60% |

Ready-to-use dusts are obtained by mixing the active ingredient with the carriers and grinding the mixture in a suitable mill.

| F8. Suspension concentrates | a) | b) | c) | d) |
|---|---|---|---|---|
| active ingredient mixture | 3% | 10% | 25% | 50% |
| ethylene glycol | 5% | 5% | 5% | 5% |
| nonylphenol polyglycol ether | — | 1% | 2% | — |
| (15 mol of ethylene oxide) | | | | |
| sodium lignosulfonate | 3% | 3% | 4% | 5% |
| carboxymethylcellulose | 1% | 1% | 1% | 1% |
| 37% aqueous formaldehyde | 0.2% | 0.2% | 0.2% | 0.2% |
| solution | | | | |
| silicone oil emulsion | 0.8% | 0.8% | 0.8% | 0.8% |
| water | 87% | 79% | 62% | 38% |

The finely ground active ingredient is intimately mixed with the adjuvants, giving a suspension concentrate from which suspensions of any desired concentration can be obtained by dilution with water.

### EXAMPLES

### Example 1

A study is performed to examine the crop phytotoxicity observed using the method of the present invention. The test crop species is Spring Wheat. Treatments are applied as outlined in Table 1. *Bicyclopyrone is applied as TALINOR™ (which contains 3.41% bicyclopyrone and 23.16% bromoxynil) in conjunction with CoAct+ at 2.75 fl oz/ha. All treatments are applied with a non-ionic surfactant (R-11 available from Wilbur-Ellis Company) at 0.25% v/v in the spray tank. Where UAN is employed, UAN 32 (45% ammonium nitrate, 35% urea, 20% water) is used at 15% v/v in the spray tank. Crop plants are visually assessed for % weed control at 15, 22 and 30 days after application (DAA).

TABLE 1

| | | | DAA % Phytotoxicity | | |
|---|---|---|---|---|---|
| | | Rate g/ha | 15 | 22 | 30 |
| 1 | Non-treated | n/a | 0 | 0 | 0 |
| | control | | | | |
| 2 | Bicyclopyrone* | 37.5 | 0 | 0 | 0 |
| 3 | Bicyclopyrone* + | 37.5 | 19 | 15 | 4 |
| | UAN | | | | |
| 4 | Mesosulfuron + | 15 | 0 | 0 | 0 |
| | UAN | | | | |
| 5 | Pyroxsulam + | 18 | 0 | 0 | 0 |
| | UAN | | | | |
| 6 | Bicyclopyrone* + | 37.5 + 15 | 0 | 0 | 0 |
| | Mesosulfuron | | | | |
| 7 | Bicyclopyrone* + | 37.5 + 15 | 0 | 0 | 0 |
| | Mesosulfuron + | | | | |
| | UAN 32 | | | | |
| 8 | Bicyclopyrone* + | 37.5 + 18 | 0 | 0 | 0 |
| | Pyroxsulam | | | | |
| 9 | Bicyclopyrone* + | 37.5 + 18 | 0 | 0 | 0 |
| | Pyroxsulam + | | | | |
| | UAN | | | | |

As can be seen the use of the nitrogen additive (UAN) along with bicyclopyrone causes some phytotoxicity in the wheat (row 3). This phytotoxicity is completely removed when various ALS-inhibiting herbicides are added to the composition (rows 7 and 9).

### Example 2

A study is performed to examine the weed control obtained using the method of the present invention. Test species is Bromus tectorum (BROTE). Treatments are applied as outlined in Table 2. *Bicyclopyrone is applied as TALINOR™ (which contains 3.41% bicyclopyrone and 23.16% bromoxynil) in conjunction with CoAct+(a sodium bicarbonate containing adjuvant) at 2.75 fl oz/ha. All treatments are applied with a non-ionic surfactant (R-11 available from Wilbur-Ellis Company) at 0.25% v/v in the spray tank. Where UAN is employed, UAN 32 (45% ammonium nitrate, 35% urea, 20% water) is used at 15% v/v in the spray tank. The plants are visually assessed for % weed control at 15, 22 and 30 days after application (DAA).

TABLE 2

| | | | DAA % Phytotoxicity | | |
|---|---|---|---|---|---|
| TRT | Composition | Rate | 15 | 22 | 30 |
| 1 | Nontreated | n/a | 0 | 0 | 0 |
| | control | | | | |
| 2 | Bicyclopyrone* | 37.5 | 6 | 5 | 5 |
| 3 | Bicyclopyrone* + | 37.5 | 6 | 3 | 3 |
| | UAN | | | | |
| 4 | Mesosulfuron + | 15 | 45 | 72 | 84 |
| | UAN | | | | |
| 5 | Pyroxsulam + | 18 | 48 | 83 | 100 |
| | UAN | | | | |
| 6 | Bicyclopyrone* + | 37.5 + 15 | 20 | 13 | 5 |
| | Mesosulfuron | | | | |
| 7 | Bicyclopyrone* + | 37.5 + 15 | 48 | 69 | 70 |
| | Mesosulfuron + | | | | |
| | UAN | | | | |
| 8 | Bicyclopyrone* + | 37.5 + 18 | 45 | 76 | 90 |
| | Pyroxsulam | | | | |
| 9 | Bicyclopyrone* + | 37.5 + 18 | 33 | 91 | 100 |
| | Pyroxsulam + | | | | |
| | UAN | | | | |

As can be seen the use of the nitrogen additive (UAN) along with bicyclopyrone and various ALS-inhibiting herbicides (rows 7 and 9) continues to provide extremely good control of the test species.

1. A method of selectively controlling unwanted vegetation at a locus comprising a crop and the unwanted vegetation, wherein the method comprises applying to the locus a herbicidal composition comprising:—
a. bicyclopyrone;
b. a nitrogen-based fertilizer additive; and
c. an ALS-inhibiting herbicide.

2. A method according to claim 1, wherein the nitrogen-based fertilizer additive is selected from ammonium sulfate and Urea Ammonium Nitrate.

3. A method according to claim 1, wherein the ALS-inhibiting herbicide is selected from the group consisting of an imidazilinone herbicide, a pyrimidinylthiobenzoic acid herbicide, a sulfonylaminocarbonyltriazolinone herbicide, a sulfonylurea herbicide and a triazolopyrimidine herbicide.

4. A method according to claim 3, wherein the ALS-inhibiting herbicide is the sulfonylurea herbicide mesosulfuron.

5. A method according to claim 3, wherein the ALS-inhibiting herbicide is the triazolopyrimidine herbicide pyroxsulam.

6. A method according to claim 1, wherein the herbicidal composition further comprises bromoxynil.

7. A method according to claim 1, wherein the bicyclopyrone is applied to the locus at a rate from 37.5 to 50 g ai/ha and the ALS-inhibiting herbicide is applied at a rate from 10-60 g ai/ha.

8. A method according to claim 1, wherein components (a), (b) & (c) are applied post-emergence to the locus.

9. A method according to claim 1, wherein the crop is wheat.

10. A method according to claim 1, wherein the unwanted vegetation comprises Bromus tectorum.

11. A herbicide composition comprising:
a. bicyclopyrone;
b. a nitrogen-based fertilizer additive; and
c. an ALS-inhibiting herbicide.

12. A herbicide composition according to claim 11, wherein the ALS-inhibiting herbicide is mesosulfuron and/or pyroxsulam.

13. A herbicide composition according to claim 11, further comprising an additional herbicide.

14. A herbicide composition according to claim 13, wherein the additional herbicide is bromoxynil.

15. Use of an ALS-inhibiting herbicide to reduce the herbicidal effect of bicyclopyrone in crop plants.
